(19) United States
(12) Patent Application Publication
(10) Pub. No.: US 2025/0327352 A1
(43) Pub. Date: Oct. 23, 2025

(54) DRIVE DEVICE FOR A CLOSURE ELEMENT OF A MOTOR VEHICLE

(71) Applicant: Brose Fahrzeugteile SE & Co. Kommanditgesellschaft, Bamberg, Bamberg (DE)

(72) Inventors: Michael Schneiderbanger, Rattelsdorf (DE); Daniela Schweizer, Coburg (DE)

(21) Appl. No.: 18/853,841

(22) PCT Filed: Apr. 4, 2023
(86) PCT No.: PCT/EP2023/058812

§ 371 Date: Oct. 3, 2024

(30) Foreign Application Priority Data
Apr. 5, 2022 (DE) 10 2022 108 114.1

(51) Int. Cl. E05F 15/622

(52) U.S. Cl. CPC E05F 15/622; E05Y 2201/212; E05Y 2201/224; E05Y 2800/28; E05Y 2800/342; E05Y 2900/546

(57) ABSTRACT

Drive apparatus for a closure element of a vehicle. The drive apparatus has a drive train with two drive sections, each having a drive connection. The drive sections are linearly movable with respect to each other in order to generate linear drive movements between the drive connections along a geometric axis between a retracted position and an extended position. An end stop is provided to limit the drive movement between the drive connections to the extended position, wherein the end stop has end stop faces movable toward each other on the drive sections and a damping device which, during a drive movement into the end stop, damps the drive movement in a manner which is dependent on its speed. The damping device has a damping element which, during the drive movement, is deformable by an axial impact of the end stop faces on each other or on an intermediate element.

### CROSS-REFERENCE TO RELATED APPLICATION

This application is a national stage application under 35 U.S.C. 371 of International Patent Application Serial No. PCT/EP2023/058812, entitled “Drive Device for a Closure Element of a Motor Vehicle,” filed Apr. 4, 2023, which claims priority from German Patent Application No. DE 10 2022 108 114.1, filed Apr. 5, 2022, the disclosure of which is incorporated herein by reference.

### FIELD OF THE TECHNOLOGY

Various embodiments relate to a drive apparatus for a closure element of a motor vehicle.

### BACKGROUND

The known prior art (DE 10 2017 127 859 A1), on which some embodiments are based, relates to a drive apparatus.

The known drive apparatus is designed as a spindle drive. The spindle drive serves for the adjustment of a closure element, as defined above, of a motor vehicle. To this end, the spindle drive is equipped with a drive motor and with a spindle/spindle nut mechanism which is connected downstream of the drive motor in order to generate drive movements. In order to divert the drive movements, the spindle drive has two drive sections, each having a drive connection, wherein the drive connections are moved axially apart from each other in the case of extension of the spindle drive and are moved axially toward each other in the case of retraction of the spindle drive. A spring arrangement is integrated into the known drive apparatus, by means of which spring arrangement the two drive sections, which are movable with respect to each other, are pretensioned against each other into the extended position of the drive apparatus. Here, the spring arrangement provides spring forces of considerable magnitude. In order to increase the operational safety, a damping device is therefore provided in the case of the known spindle drive between the end stop faces which move toward each other in the case of a movement into the extended position of the drive apparatus, which damping device, during a drive movement into the end stop, damps the drive movement in a manner which is dependent on the speed of the drive movement. The known damping device has a damping element in the form of a plastically deformable bushing made of plastic, wherein a damping action of an impact between the end stop faces is brought about by virtue of the fact that the damping element is axially loaded between the end stop faces, thereby deforms and, in the deformed state, is moved by the one end stop face in the direction of the other end stop face. This other end stop face is formed by a further bushing made of plastic. Both bushings, also called stop nuts, are axially fixed on the spindle during assembly. The assembly of the drive apparatus is therefore relatively complex.

The challenge here is to improve on the known prior art.

### SUMMARY

The term “closure element” is to be understood broadly. Closure elements of this type include tailgates, trunk lids, engine hoods, doors, in particular side doors, also sliding doors, load compartment floors or the like of a motor vehicle.

The drive apparatus in question has gained more and more significance in recent years, in order to provide a high degree of comfort to the user. This applies in particular to large closure elements of a motor vehicle, the weight of which makes manual opening or closing movements of the closure element difficult. In a case of this type, the drive apparatus can assume the opening and/or closing operation and, in addition, allows the closure element to be held in the open position or intermediate positions.

Various embodiments are based on the problem of configuring and developing the known drive apparatus in such a way that further optimization is achieved as regards the aforementioned challenge.

The above problem is solved various features described herein.

One consideration is that the damping element is an axially fixed and in particular integral component of a train component of one of the two drive sections. This means that separate components on the train component, for example a separate stop nut, can be dispensed with for the formation of the damping device. In various embodiments, the damping element is therefore not separately manufactured and assembled, but formed by a portion of the train component that is already shaped in the course of production, in particular machining or rotating production, of the train component. In this way, the damping device and thus the entire drive apparatus are of particularly simple construction and accordingly easy to set up.

It should be noted that the damping action in question here, in some embodiments, does not occur during normal operation of the drive apparatus, but rather only in the case of an improper use situation when, for example, the user applies excessive opening forces in the case of manual opening of the closure element or, in the case of a failure of components when, for example, a drive connection of the drive apparatus accidentally detaches from the closure element or the edge region of the closure element opening. The plastic deformation of the damping element therefore occurs only in the indicated special situations, so as to prevent substantial material damage or personal injury.

Specifically, it is proposed that the plastically deformable damping element is an axially fixed, radially outwardly facing projection, in particular a circumferential collar, of a train component of the one drive section.

Various embodiments define a structure of the drive apparatus, in which the drive section comprising the drive element has a rod and the other drive section has a tube. In various embodiments, the rod is the spindle of a spindle/spindle nut mechanism, and, in some embodiments, the tube is a spindle nut tube which is connected in an axially fixed manner to the spindle nut of the spindle/spindle nut mechanism.

Various embodiments specify that the radially outwardly facing projection can be part of a shoulder. The radially outwardly facing projection cans then be formed by a groove introduced into the shoulder, whereby a plastically deformable damping element can be provided in a simple manner which is adapted to the particular requirements, in particular in terms of its thickness.

Various embodiments define materials and arrangements of the intermediate element and of a guide element.

Various embodiments specify positions of the end stop faces which, in said situations of improper use, bring about the plastic deformation of the damping element, optionally via the intermediate element.

Various embodiments provide a drive apparatus for a closure element of a motor vehicle, wherein the drive apparatus has a drive train with two drive sections, each having a drive connection, wherein the drive sections are linearly movable with respect to each other in order to generate linear drive movements between the drive connections along a geometric axis between a retracted position and an extended position, wherein an end stop is provided in order to limit the drive movement between the drive connections to the extended position, wherein the end stop has end stop faces movable toward each other on the drive sections and a damping device which, during a drive movement into the end stop, damps the drive movement in a manner which is dependent on its speed, wherein the damping device has a damping element which, during the drive movement, is plastically deformable by an axial impact of the end stop faces on each other or on an intermediate element, characterized in that the plastically deformable damping element is an axially fixed, radially outwardly facing projection, in particular a circumferential collar, of a train component of the one drive section.

In various embodiments, the drive section having the damping element has a rod forming the train component, and the other drive section has a tube, in that the rod is in sliding and/or screwing engagement with the inside of the tube and that the damping element is an axially fixed component of the rod, in some embodiments that the rod is the spindle of a spindle/spindle nut mechanism, and further, in some embodiments, that the tube is a spindle nut tube which is connected in an axially fixed manner to a spindle nut of the spindle/spindle nut mechanism.

In various embodiments, the radially outwardly facing projection is made of metal and/or is furthermore rotationally fixed with respect to the train component and in particular furthermore designed in one piece with the train component, in some embodiments, that the radially outwardly facing projection is part of a shoulder for axially securing a stop washer or sleeve which forms the intermediate element between the end stop faces, and/or of a guide element arranged axially outside the end stop, in particular a guide washer or sleeve, for axial guidance in the tube, further, in some embodiments, that the radially outwardly facing projection is formed by a groove introduced into the shoulder.

In various embodiments, the intermediate element made of metal and/or is rotationally fixed with respect to the train component, and/or that the guide element is made of plastic and/or is rotatable with respect to the train component.

In various embodiments, the damping element forms one of the end stop faces, in some embodiments, the other end stop face is formed on the inside of the tube and in particular is formed by at least one radially inwardly facing projection, in some embodiments, the projection forms an axial end of the spindle nut and/or is in contact with an axial end of the spindle nut.

### BRIEF DESCRIPTION OF THE DRAWINGS

Various aspects are explained in more detail below with reference to a drawing that merely illustrates exemplary embodiments. In the drawing:

FIG. 1 shows a highly schematic illustration of the rear region of a motor vehicle with a tailgate, which is equipped with a proposed drive apparatus, and

FIG. 2 shows a sectional side view of the apparatus according to FIG. 1, a) in the retracted position in normal operation, and b) in the extended position after the damping device of the apparatus has been used.

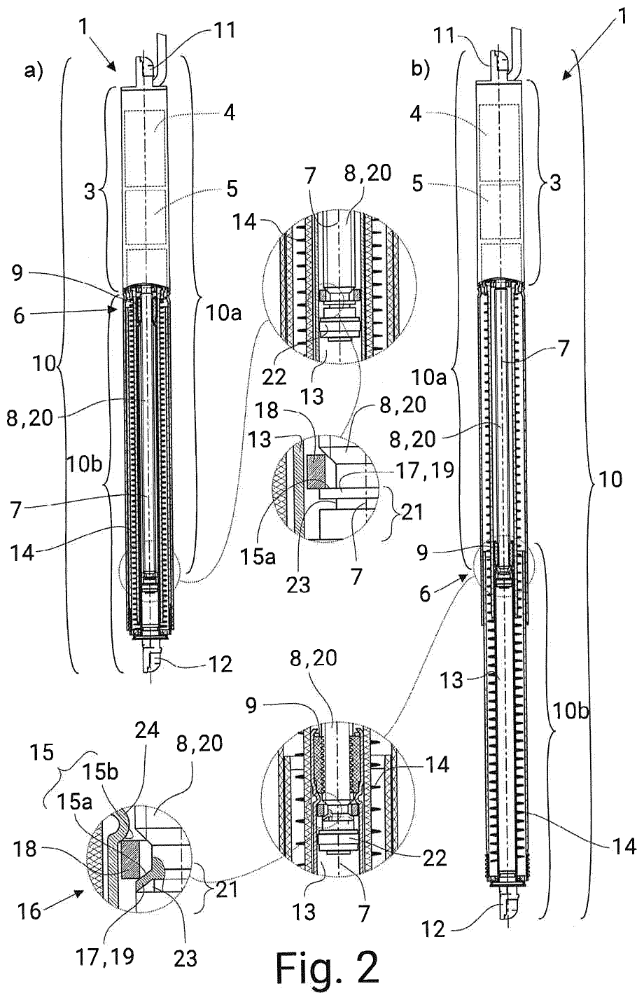

### DETAILED DESCRIPTION

The drive apparatus 1 shown in the drawing is designed as a spindle drive and serves for the motorized adjustment of a closure element 2 of a motor vehicle, which closure element is designed here as a tailgate. With regard to the further understanding of the term “closure element” 2, reference may be made to the introductory part of the description. In the following, various aspects will be described on the basis of a closure element 2 which is configured as a tailgate, since it is precisely here that there has to be particularly high reliability of the drive apparatus 1 on account of the comparatively high forces which are brought about by the weight of the closure element 2.

The spindle drive is equipped with an (electric drive unit 3 which has an electric drive motor 4 and an intermediate gear mechanism 5 which is connected downstream of the drive motor 4. A feed mechanism, here a spindle/spindle nut mechanism 6 with a geometric gear axis 7 for generating linear drive movements between two drive connections 11, 12 is connected downstream of the drive unit 3 overall in terms of drive. In a way that is customary per se, the spindle/spindle nut mechanism 6 has a spindle 8 with a spindle external thread and a spindle nut 9 with a spindle nut internal thread, which threads form a screw engagement with each other.

The drive apparatus 1 in the form of the spindle drive has a drive train 10 with two drive sections 10a, 10b, each drive section 10a, 10b having an associated drive connection 11, 12. The two drive sections 10a, 10b, driven by the spindle/spindle nut mechanism 6, are linearly movable to each other. Thus, in the exemplary embodiment which is chosen here, the spindle 8 is assigned to the here upper drive section 10a and therefore to the first drive connection 11, whereas the spindle nut 9 is assigned to the other, here lower, drive section 10b and therefore to the second drive connection 12. By actuation of the drive unit 3, the spindle 8 is set in rotation and the spindle nut 9 is moved axially relative to the spindle 8. In various embodiments, the spindle nut 9 is connected in an axially fixed manner to a spindle nut tube 13, the spindle nut tube 13 in turn being connected to the second drive connection 12. In this way, the relative movement between the spindle 8 and the spindle nut 9 is transmitted via the spindle nut tube 13 to the second drive connection 12, as a result of which the drive connections 11, 12 move relative to each other correspondingly.

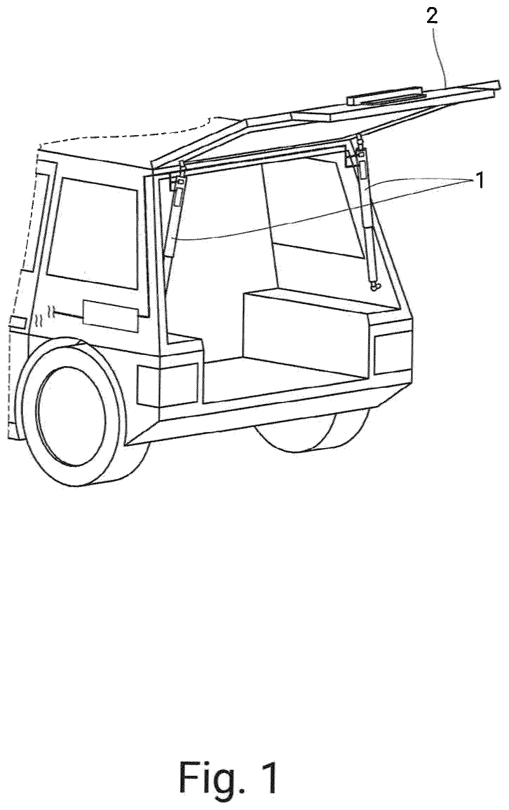

In the assembled state shown in FIG. 1, the spindle drive is coupled in terms of drive to the closure element 2. Here, in the manner described above, the spindle drive assumes the adjustment of the closure element 2 (here the tailgate), between the open position shown in FIG. 1 and a closed position (not shown). For the sake of completeness, it will be noted that the drive apparatus 1, which is shown here as a spindle drive by way of example, can also be actuated manually; that is to say, the user can also open and/or close the closure element 2 manually. In order to make a manual adjustment possible despite the drive unit 3 with drive motor 4 which is optionally provided here, the drive apparatus 1 can have, furthermore, an overload coupling (not shown). It is also conceivable in principle for a drive apparatus 1 to be configured such that it can be actuated in a purely manual manner, and for a drive unit 3 as described above to be dispensed with.

Moreover, the drive apparatus 1 or the spindle drive has a spring arrangement 14 which pretensions the two drive sections 10a, 10b against each other into the extended position and therefore presses the closure element 2 into the open position. In some embodiments, the spring arrangement 14 has a compression spring.

In the exemplary embodiment shown in FIG. 1, a total of two drive apparatuses 1, in some embodiments two spindle drives, are provided, which are arranged at two opposite edge regions of a closure element opening, here a tailgate opening. In principle, however, it can also be the case that only one such drive apparatus 1 is provided, which is then arranged in particular at one of the edge regions of the closure element opening.

Furthermore, the drive apparatus 1 described here has an end stop 15 in order to limit the drive movement between the drive connections 11, 12 to the extended position. The end stop 15 has a first end stop face 15a and a second end stop face 15b, which are each provided on an associated drive section 10a, 10b and are movable toward each other, and a damping device 16 which, during a drive movement into the end stop 15, damps the drive movement in a manner which is dependent on its speed. Here, a considerable impact force occurs in the end stop 15, which impact force is to be taken up by the damping device 16 and is to be absorbed as fully as possible.

A drive apparatus 1 for a closure element 2 of a motor vehicle is provided, wherein the drive apparatus 1 has a drive train 10 with two drive sections 10a, 10b, each having a drive connection 11, 12, wherein the drive sections 10a, 10b are linearly movable with respect to each other in order to generate linear drive movements between the drive connections 11, 12 along a geometric axis (7 between a retracted position and an extended position, wherein an end stop 15 is provided in order to limit the drive movement between the drive connections 11, 12 to the extended position, wherein the end stop 15 has end stop faces 15a, 15b movable toward each other on the drive sections 10a, 10b and a damping device 16 which, during a drive movement into the end stop 15, damps the drive movement in a manner which is dependent on its speed, wherein the damping device 16 has a damping element 17 which, during the drive movement, is plastically deformable by an axial impact of the end stop faces 15a, 15b on each other or on an intermediate element 18.

It is essential now that the plastically deformable damping element 17 is an axially fixed, radially outwardly facing projection 19, in particular a circumferential collar, of a train component 20 of the one drive section 10a.

A train component 20 is a component in the drive train 10 that serves to transmit the drive movements. The component itself therefore has the function of movement transmission. The projection 19 follows the movements of the train component 20 and is in particular worked out from the train component 20, for example by machining.

Furthermore, it can be provided that the drive section 10a having the damping element 17 has a rod forming the train component 20, and the other drive section 10b has a tube, that the rod is in sliding and/or screwing engagement with the inside of the tube and that the damping element 17 is an axially fixed component of the rod, in some embodiments that the rod is the spindle 8 of a spindle/spindle nut mechanism 6, and further in some embodiments that the tube is a spindle nut tube 13 which is connected in an axially fixed manner to the spindle nut 9 of the spindle/spindle nut mechanism 6.

As previously described, the drive apparatus 1 can be designed as a spindle drive, i.e. has a spindle/spindle nut mechanism 6 as feed mechanism. In principle, however, it is also conceivable that the rod and the tube are threadless and, for example, are part of a drive apparatus 1 designed as a gas pressure spring.

It can further be provided that the radially outwardly facing projection 19 is made of metal and/or is furthermore rotationally fixed with respect to the train component 20 and in particular furthermore designed in one piece with the train component 20, in some embodiments the radially outwardly facing projection 19 is part of a shoulder 21 for axially securing a stop washer or sleeve which forms the intermediate element 18 between the end stop faces 15a, 15b, and/or of a guide element 22 arranged axially outside the end stop 15, in particular a guide washer or sleeve, for axial guidance in the tube, further in some embodiments that the radially outward facing projection 19 is formed by a groove 23 introduced into the shoulder 21.

In some embodiments, the shoulder 21 serves, toward one axial side, to support the intermediate element 18, which in turn is axially secured on its other side by a portion, in particular a threaded portion, of the train component 20, and, toward the other axial side, to support the guide element 22, which in turn is axially secured on its other side by a further support element. The guide element 22 can be arranged outside the end stop 15, hence outside the space between the end stop faces 15a, 15b.

It is further provided, in some embodiments, that the intermediate element 18 is made of metal and/or is rotationally fixed with respect to the train component 20, and/or that the guide element 22 is made of plastic and/or is rotatable with respect to the train component 20.

In the case of the intermediate element 18, metal has the advantage that it optimally transfers the force for deformation of the projection 19 from one end stop face 15b to the other end stop face 15a. In principle, however, the intermediate element 18 can also be made from another material, for example plastic. In the case of the guide element 22, plastic has the advantage that it can optimally slide along within the tube. In principle, however, this guide element 22 can also be made from another material, for example metal.

It is further provided, in some embodiments, that the damping element 17 forms one of the end stop faces 15a, in some embodiments that the other end stop face 15b is formed on the inside of the tube and in particular is formed by at least one radially inwardly facing projection 24, in some embodiments that the projection 24 forms an axial end of the spindle nut 9 and/or is in contact with an axial end of the spindle nut 9.

The projection 24 can be produced by forming, for example by rolling or the like.

1. A drive apparatus for a closure element of a motor vehicle, wherein the drive apparatus comprises a drive train with two drive sections, each comprising a drive connection, wherein the drive sections are linearly movable with respect to each other in order to generate linear drive movements between the drive connections along a geometric axis between a retracted position and an extended position, wherein an end stop is provided in order to limit the drive movement between the drive connections to the extended position, wherein the end stop has end stop faces movable toward each other on the drive sections and a damping device which, during a drive movement into the end stop, damps the drive movement in a manner which is dependent on its speed, wherein the damping device has a damping element which, during the drive movement, is plastically deformable by an axial impact of the end stop faces on each other or on an intermediate element, wherein the plastically deformable damping element is an axially fixed, radially outwardly facing projection of a train component of the one drive section.

2. The drive apparatus as claimed in claim 1, wherein the drive section having the damping element comprises a rod forming the train component, and the other drive section comprises a tube, wherein the rod is in sliding and/or screwing engagement with the inside of the tube and that the damping element is an axially fixed component of the rod.

3. The drive apparatus as claimed in claim 1, wherein the radially outwardly facing projection is made of metal and/or is furthermore rotationally fixed with respect to the train component.

4. The drive apparatus as claimed in claim 1, wherein the intermediate element made of metal and/or is rotationally fixed with respect to the train component, and/or that the guide element is made of plastic and/or is rotatable with respect to the train component.

5. The drive apparatus as claimed in claim 1, wherein the damping element forms one of the end stop faces.

6. The drive apparatus of claim 1, wherein the plastically deformable damping element is a circumferential collar.

7. The drive apparatus as claimed in claim 2, wherein the rod is the spindle of a spindle/spindle nut mechanism.

8. The drive apparatus of claim 7, wherein the tube is a spindle nut tube which is connected in an axially fixed manner to a spindle nut of the spindle/spindle nut mechanism.

9. The drive apparatus as claimed in claim 3, wherein the radially outwardly facing projection is furthermore designed in one piece with the train component.

10. The drive apparatus as claimed in claim 9, wherein the radially outwardly facing projection is part of a shoulder for axially securing a stop washer or sleeve which forms the intermediate element between the end stop faces, and/or of a guide element arranged axially outside the end stop for axial guidance in the tube.

11. The drive apparatus as claimed in claim 10, wherein the radially outwardly facing projection is formed by a groove introduced into the shoulder.

12. The drive apparatus as claimed in claim 5, wherein the damping element forms one of the end stop faces wherein the other end stop face is formed on the inside of the tube.

13. The drive apparatus as claimed in claim 12, wherein the damping element forms one of the end stop faces wherein the other end stop face is formed on the inside of the tube and is formed by at least one radially inwardly facing projection,

14. The drive apparatus as claimed in claim 13, wherein the projection forms an axial end of the spindle nut and/or is in contact with an axial end of the spindle nut.
